(19) United States
(12) Patent Application Publication
(10) Pub. No.: US 2016/0006089 A1
(43) Pub. Date: Jan. 7, 2016

(54) Potassium-Oxygen Batteries Based on Potassium Superoxide

(71) Applicants: Yiying WU, Columbus, OH (US); Xiaodi REN, Columbus, OH (US)

(72) Inventors: Yiying Wu, Columbus, OH (US); Xiaodi Ren, Columbus, OH (US)

(21) Appl. No.: 14/762,768

(22) PCT Filed: Jan. 23, 2014
(86) PCT No.: PCT/US14/12730

§ 371 Date: Jul. 22, 2015

Related U.S. Application Data
(60) Provisional application No. 61/755,753, filed on Jan. 23, 2013.

(51) Int. Cl. H01M 12/08; H01M 4/90; H01M 12/02; H01M 4/96

(52) U.S. Cl. CPC H01M 12/08; H01M 4/96; H01M 4/9041; H01M 12/02; H01M 2220/30; H01M 2300/0028

(57) ABSTRACT

Potassium-oxygen (K—O₂) batteries based on potassium superoxide (KO₂) are provided. The K—O₂ batteries can exhibit high specific energy a low discharge/charge potential gap (e.g., a discharge/charge potential gap of less than 50 mV at a current density of 0.16 mA/cm²) without the use of any catalysts. The discharge product of the K—O₂ batteries is K—O₂, which is both kinetically stable and thermodynamically stable. As a consequence of the stability of the discharge product, the K—O₂ batteries can exhibit improved operational stability relative to other metal-air batteries.

### STATEMENT REGARDING FEDERALLY SPONSORED RESEARCH OR DEVELOPMENT

This invention was made with Government Support under Grant No. DMR-0955471 awarded by the National Science Foundation. The Government has certain rights in the invention.

### TECHNICAL FIELD

This application relates generally to potassium-oxygen (K—O₂) batteries based on potassium superoxide (KO₂).

### BACKGROUND

Metal-air batteries (MABs) have attracted interest for a variety of energy storage applications, largely because MABs exhibit much larger specific energies than current Li-ion batteries. In particular, Li—O₂ batteries have attracted attention from researchers due to their high specific energy.

In spite of their potential, lithium-oxygen batteries have significant shortcomings that have hampered their widespread adoption. The discharge process in Li—O₂ batteries involves the reduction of oxygen to superoxide (O₂⁻), the formation of LiO₂, and subsequent disproportionation of the LiO₂ into Li₂O₂ and O₂; the charge process in Li—O₂ batteries is the direct oxidation of Li₂O₂ into O₂. As a result of the asymmetric reaction mechanism, the charge reaction in Li—O₂ batteries has a much higher overpotential (˜1-1.5 V) than the discharge reaction (˜0.3 V). As a consequence, Li—O₂ batteries exhibit a relatively low round-trip energy efficiency of around 60%. In addition, the instability of the electrolyte and carbon electrode under the high charging potential (>3.5 V) contributes to the low rechargeability of Li—O₂ batteries. In addition, the insulating nature of Li₂O₂ hinders the charge transfer reactions and result in a limited battery capacity.

Improved battery designs are needed to provide MABs that overcome the shortcomings of existing Li—O₂ battery designs.

### SUMMARY

Potassium-oxygen (K—O₂) batteries based on potassium superoxide (KO₂) are provided. Potassium-oxygen batteries can comprise a first electrode comprising potassium, a second electrode, and an electrolyte disposed between the first electrode and the second electrode.

The first electrode can comprise potassium metal (e.g., potassium metal foil). The second electrode can comprise a porous carbon electrode. The porous carbon electrode can comprise a metal foam framework (e.g., a Ni foam framework), carbon (e.g., a carbon black powder), and a binder (e.g., a polymeric binder such as polytetrafluoroethylene (PTFE)). After discharge of the K—O₂ battery, the second electrode can further comprise KO₂. The electrolyte can be a liquid electrolyte comprising potassium cations and an aprotic solvent. For example, the electrolyte can be a K⁺ electrolyte solution comprising an ether solvent and a potassium salt. In some embodiments, the ether solvent can comprise a solvent selected from the group consisting of dimethoxyethane (DME), diglyme, tetraglyme, and butyl diglyme. In certain embodiments, the ether solvent can comprise a mixture of diglyme and butyl diglyme (e.g., in a volume ratio of 2:5). The potassium salt can be, for example, KPF₆. The K—O₂ batteries can further comprise a separator that mechanically separates the first electrode and the second electrode (e.g., a glassy fiber separator).

The K—O₂ batteries are based on the one-electron reduction of oxygen to superoxide. During discharge of the potassium-oxygen battery, a discharge product can be formed at the second electrode that is thermodynamically stable and kinetically stable. During discharge of the K—O₂ batteries, the one-electron reduction of oxygen at the second electrode can form a superoxide (O₂⁻). Once formed, the superoxide is captured by potassium ions, forming KO₂. During discharge of the K—O₂ battery, reaction (1) occurs at the second electrode

O₂+e⁻+K⁺→KO₂ (1),

and during charge of the K—O₂ battery, reaction (2) occurs at the second electrode

KO₂→O₂+e⁻+K⁺ (2).

The net discharge reaction for the K—O₂ battery is K+O₂→KO₂ (ΔG⁰=−239.4 kJ/mol, E⁰=2.48 V), corresponding to a theoretical energy density of 935 Wh/kg for the battery (based on the mass of KO₂).

By exploiting the one-electron quasi-reversible O₂/O₂⁻ redox couple, K—O₂ batteries can be designed that possess a high specific energy, a low discharge/charge potential gap (e.g., a discharge/charge potential gap of less than 50 mV at a current density of 0.16 mA/cm²), high round-trip energy efficiency (e.g., that possess a round-trip energy efficiency of >95%), and good recyclability (e.g., that are rechargeable).

### DESCRIPTION OF DRAWINGS

FIG. 1 is a schematic illustration of a K—O₂ battery.

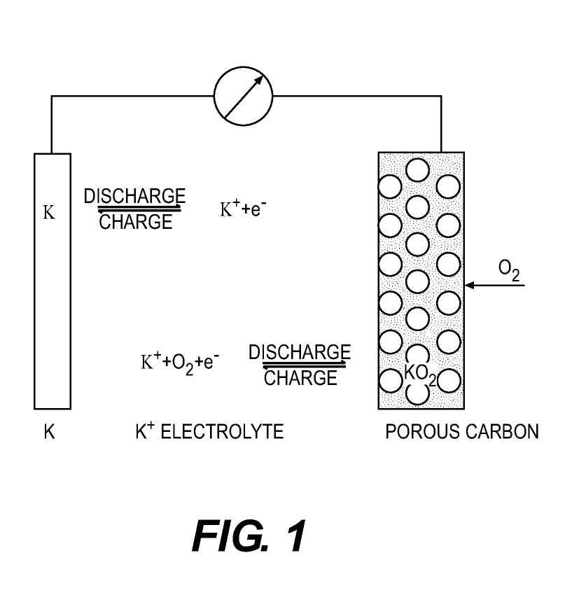

FIG. 2A is a plot of cyclic voltammograms for oxygen reduction and oxidation on a glassy carbon electrode (three-electrode setup) in oxygen-saturated acetonitrile containing 0.1 M TBAPF₆, 0.1 M LiClO₄, and 0.1 M KPF₆. The current density of the oxygen reduction and oxidation in the presence of the LiClO₄ electrolyte was enlarged three times for clarity. Good reversibility of the O₂/O₂⁻ redox couple can be observed in the presence of the tetrabutylammonium cation (TBA⁺) due to its large size (and thus low charge density).

FIG. 2B is a plot of cyclic voltammograms for oxygen reduction and oxidation on a porous carbon electrode (two-electrode battery setup) in oxygen-saturated dimethoxyethane (DME) containing 0.5 M KPF6. Oxygen pressure during measurement was 1 atm.

FIG. 3A is a plot of voltage over time for the first discharge and the first charge cycle of a K—O₂ battery including 0.5 M KPF₆ in DME as an electrolyte. Following measurement of the first discharge curve, the K metal electrode was replaced with a fresh K metal electrode prior to measurement of the first charge curve. Both the first discharge curve and the first charge curve were measured at a current density of 0.16 mA/cm². The electrode geometric area was 0.64 cm². The horizontal dash line indicates the calculated thermodynamic potential of the K—O₂ battery.

FIG. 3B is a plot of voltage over time for the first discharge and the first charge cycle of a Li—O₂ battery including 1 M LiCF₃SO₃ in tetraglyme as an electrolyte. Both the first discharge curve and the first charge curve were measured at a current density of 0.16 mA/cm². The electrode geometric area was 0.64 cm². The horizontal dash line indicates the calculated thermodynamic potential of the Li—O₂ battery.

FIG. 4A is a plot of the overlayed x-ray diffraction (XRD) pattern of a carbon electrode after the discharging process (bottom trace) and a KO₂-loaded electrode after the charging process (top trace). Also included are lines representing the standard XRD pattern of KO₂ (JCPDF No. 43-1020).

FIG. 4B is a plot of the overlayed Raman spectra of a carbon electrode before the discharging process (bottom trace) and after the discharging process (top trace).

FIG. 5 is a plot of voltage over time for the charging process of a K—O₂ battery including an artificial discharged electrode (a KO₂-loaded electrode). The charge curve were measured at a current density of 0.16 mA/cm²

FIG. 6 is a plot of the first two continuous battery discharge-charge cycles of a K—O₂ battery including 0.5 M KPF₆ in a butyl diglyme/diglyme mixture (volume ratio 2:5) as an electrolyte. Both the discharge curves and the charge curves were measured at a current density of 0.16 mA/cm².

FIG. 7 is a plot of the voltage profile of potassium electrodeposition and dissolution at 0.16 mA/cm² in a K|K symmetric cell (electrolyte=0.5 M KPF₆ in a mixture of butyl diglyme and diglyme (volume ratio of 2:5)). Ether and polyether solvents, particularly those containing terminal oxygen moieties, can coordinate to alkali metal ions and generate solvated electrons or metal anions. These species can be highly reductive in nature, and may induce the decomposition of the electrolyte. Mixtures of butyl diglyme and diglyme (e.g., in a volume ratio of 2:5) were found to stable in cells containing a potassium metal electrode due to the limited tendency of butyl diglyme and diglyme to coordinate potassium cations.

### DETAILED DESCRIPTION

Disclosed herein are potassium-oxygen batteries. Potassium-oxygen batteries can comprise a first electrode comprising potassium, a second electrode, and an electrolyte disposed between the first electrode and the second electrode.

The K—O₂ batteries are based on the one-electron reduction of oxygen to superoxide. The discharge product of the K—O₂ batteries (e.g., KO₂) can be both kinetically stable and thermodynamically stable. During discharge of the K—O₂ battery, the one-electron reduction of oxygen at the second electrode forms superoxide. Once formed, the superoxide is captured by potassium ions, forming potassium superoxide. By exploiting the quasi-reversible O₂/O₂⁻ redox couple, K—O₂ batteries can be designed that possess a high specific energy, a low discharge/charge potential gap, high round-trip energy efficiency, and good recyclability.

During discharge of the K—O₂ battery, reaction (1) occurs at the second electrode

O₂+e⁻+K⁺→KO₂ (1)

and during charge of the K—O₂ battery, reaction (2) occurs at the second electrode

KO₂→O₂+e⁻+K⁺ (2).

The net discharge reaction for the K—O₂ battery is K+O₂→KO₂ (ΔG⁰=−239.4 kJ/mol, E⁰=2.48 V), corresponding to a theoretical energy density of 935 Wh/kg for the battery (based on the mass of KO₂).

As described above, the first electrode of the K—O₂ batteries (e.g., the anode of the K—O₂ batteries) can comprise potassium. The potassium can be, for example, potassium metal (e.g., a potassium foil). The first electrode can be fabricated in any suitable geometry so as to afford a functioning K—O₂ battery having the dimensions and performance characteristics desired for a particular application. For example, the first electrode can be in the form of a metal wire, metal grid, metal mesh, expanded metal, metal foil, or metal sheet. In certain embodiments, the first electrode can comprise potassium metal foil.

The K—O₂ batteries further comprise a second electrode. The second electrode functions as a cathode during discharge of the battery. The second electrode can be fabricated in any suitable geometry so as to afford a functioning K—O₂ battery having the dimensions and performance characteristics desired for a particular application. For example, during discharge of the K—O₂ battery, the second electrode reacts with molecular oxygen (e.g., air or O₂ gas). Accordingly, the second electrode can be an electrode configured to facilitate an electrochemical reaction with O₂ gas. For example, the second electrode can be a gas diffusion electrode. Gas diffusion electrodes that are permeable to oxidizing gases (e.g., that are permeable to O₂) are known in the art. Suitable electrodes can comprise a porous electrode body through which oxygen or air can diffuse without the application of elevated pressure.

The second electrode can be fabricated from a material or composition that conducts electrical current. For example, the second electrode can comprise a metal mesh or foam (e.g., a nickel foam), a conductive fabric (e.g., a woven or nonwoven fabric formed from conductive fibers such as carbon fibers or metal filaments), a gas diffusion media composed of carbon, or carbon on a metal mesh or foam (e.g., carbon on a nickel foam).

In some embodiments, the second electrode comprises a porous carbon electrode. The porous carbon electrode can comprise a metal foam framework (e.g., a Ni foam framework), carbon (e.g., a carbon powder, such as carbon black powders commercially available under the trade name SUPER P® from TIMCAL Ltd.), and a binder (e.g., a polymeric binder such as polytetrafluoroethylene (PTFE)). After discharge of the battery, the second electrode can further comprise potassium superoxide (KO₂), in particular solid KO₂. The solid potassium superoxide can be amorphous or crystalline. In certain embodiments, the solid potassium superoxide comprises crystalline KO₂.

The second electrode can optionally further comprise an electrocatalyst. For example, the second electrode can comprise a catalyst for the reduction of oxygen to superoxide in the course of discharging, a catalyst for the oxidation of superoxide to oxygen in the course of charging, or a combination thereof (e.g., a single electocatalyst that catalyzes both the reduction of oxygen to superoxide and the oxidation of superoxide to oxygen, or a first electocatalyst that catalyzes both the reduction of oxygen to superoxide and a second electrocatalyst that catalyzes the oxidation of superoxide to oxygen). In certain embodiments, the second electrode does not comprise an electrocatalyst.

The electrolyte can be any suitable electrolyte. The electrolyte can be a liquid electrolyte comprising potassium cations and an aprotic solvent. For example, the electrolyte can be a K⁺ electrolyte solution comprising an ether solvent.

The ether solvent can be, for example, an aprotic glycol diether, such as a mono- or oligoalkylene glycol diether (e.g., a mono- or oligo-C₁-C₄-alkylene glycol diether such as a mono- or oligoethylene glycol diether). In certain embodiments, the ether solvent comprises an aprotic glycol diether that does not include terminal oxygen moieties (e.g., an aprotic glycol diether capped with methyl or ethyl groups). Examples of suitable ether solvents include dimethoxyethane (DME), diglyme (bis(2-methoxyethyl)ether), butyl diglyme, triglyme (triethylene glycol dimethyl ether), tetraglyme (tetraethylene glycol dimethyl ether), as well as mixtures thereof.

In some embodiments, the ether solvent comprises a solvent selected from the group consisting of dimethoxyethane, diglyme, tetraglyme, and butyl diglyme. In certain embodiments, the ether solvent comprises a mixture of diglyme and butyl diglyme (e.g., in a volume ratio of 2:5).

The electrolyte can comprise any suitable potassium-containing conductive salt that is soluble in the aprotic solvent. Suitable potassium salts are known in the art, and include, for example, KPF₆, KBF₄, KClO₄, KAsF₆, KCF₃SO₃, potassium bis(oxalato)borate, potassium difluoro(oxalate)borate, K₂SiF₆, KSbF₆, KC(CF₃SO₂)₃, KN(CF₃SO₂)₂, and combinations thereof. In certain embodiments, the K⁺ electrolyte solution comprises KPF₆.

If desired, the electrolyte can further comprise additional components, including additional aprotic solvents, or a crown ether (e.g., 1,4,7,10,13,16-hexaoxacyclooctadecane).

The K—O₂ batteries can further comprise a separator that mechanically separates the first electrode and the second electrode. The separator can be disposed between the first electrode and the second electrode, so as to keep the two electrodes apart to prevent electrical short circuits. The separator can be fabricated from any suitable material that allows for the transport of ionic charge carriers between the two electrodes.

Suitable separators are known in the art, and include polymer films (e.g., porous polymer films, such as porous polyolefin films), polymeric nonwovens, and inorganic nonwovens (e.g., glass fiber nonwovens and ceramic fiber nonwovens). In some embodiments, the separator can comprise a glassy fiber separator.

The K—O₂ batteries can be rechargeable. The K—O₂ batteries can exhibit high capacitances, improved mechanical stability, high performance even after repeated charging, improved charging and discharging rates at low overvoltages, and/or a low discharge/charge potential gap (e.g., a discharge/charge potential gap of less than 50 mV at a current density of 0.16 mA/cm²).

The K—O₂ batteries described herein can be used in a variety of energy storage applications. By way of example, the K—O₂ batteries can be used in automobiles, electric bicycles, aircraft, ships or stationary energy stores. The K—O₂ batteries can also be used in portable mobile devices such as computers (e.g., laptops and tablet computers), telephones (e.g., smartphones), hearing aids, and electrical power tools (e.g., drills, screwdrivers, etc.).

The K—O₂ batteries described herein can also be used to produce potassium superoxide of formula KO₂, in particular solid KO₂. The solid potassium superoxide can be amorphous or crystalline. In certain embodiments, the solid potassium superoxide comprises crystalline KO₂. Solid potassium superoxide can be prepared by performing the electrochemical reduction of O₂ to O₂⁻ during the discharge of one of the K—O₂ batteries described above so as to form KO₂. The KO₂ can be dissolved in the liquid electrolyte, deposited on the second electrode during discharging, or combinations thereof. Once formed, the KO₂ can be isolate in solid form, in particular in crystalline form, from the second electrode by mechanical means after disassembling the K—O₂ battery. The KO₂ can also be isolate from the liquid electrolyte, for example by crystallization. The isolation of KO₂ from the liquid electrolyte can be done batch-wise or continuously. For example in a continuous process new liquid electrolyte is added to the battery while liquid electrolyte comprising KO₂ is removed during discharging in such a manner, that the total volume of the electrolyte in the cell is kept constant.

The examples below are intended to further illustrate certain aspects of the devices described herein, and are not intended to limit the scope of the claims.

### EXAMPLES

Overview Lithium-oxygen (Li—O₂) batteries are regarded as one of the most promising energy storage systems for future applications. However, the energy efficiencies of Li—O₂ batteries are greatly undermined by the large overpotentials of the discharge (formation of Li₂O₂) and charge (oxidation of Li₂O₂) reactions. In existing Li—O₂ batteries, parasitic reactions of the electrolyte and the carbon electrode induced by the high charging potential cause a decay of capacity and limit the battery life. Potassium-oxygen (K—O₂) batteries are described below that use K⁺ ions to capture O₂⁻ to form a thermodynamically stable KO₂ as the discharge product. This allows for the batteries to operate through the one-electron redox process of O₂/O₂⁻. Without the use of catalysts, these K—O₂ batteries show a low discharge/charge potential gap of less than 50 mV at modest current densities.

Introduction

Li—O₂ batteries have attracted attention from researchers due to their high specific energy. Non-aqueous lithium-oxygen batteries, which are based on the net reaction of 2Li+O₂⇄Li₂O₂ (E₀=2.96 V), have a theoretical specific energy as high as 3,505 Wh/kg. In spite of their potential, lithium-oxygen batteries have significant shortcomings that have hampered their widespread adoption. The discharge process in Li—O₂ batteries involves the reduction of oxygen to superoxide (O₂⁻), the formation of LiO₂, followed by its subsequent disproportionation into Li₂O₂ and O₂; the charge process in Li—O₂ batteries is the direct oxidation of Li₂O₂ into O₂. As a result of the asymmetric reaction mechanism, the charge reaction in Li—O₂ batteries has a much higher overpotential (˜1-1.5 V) than the discharge reaction (˜0.3 V). As a consequence, Li—O₂ batteries exhibit a relatively low round-trip energy efficiency of around 60%. In addition, the instability of the electrolyte and carbon electrode under the high charging potential (>3.5 V) contributes to the low rechargeability of Li—O₂ batteries. Electrocatalysts have been explored to lower the overpotentials of the charge and discharge reactions in Li—O₂ batteries. However, electrocatalysts are often expensive and facilitate undesirable side reactions. In addition, the insulating nature of Li₂O₂ (charge transport through a Li₂O₂ film is largely suppressed once the film thickness exceeds 5˜10 nm) hinders the charge transfer reactions and result in a limited battery capacity.

Materials and Methods

Swagelok Cell Assembly

SUPER P® carbon powder (obtained from TIMCAL Ltd.) was ground with polytetrafluoroethylene (PTFE) powder (Sigma Aldrich, 1 micron size) (weight ratio=1:1). A slurry was then formed by addition of a solution of 0.5 M KPF₆ (Sigma Aldrich, 99.9%) in 1,2-dimethoxyethane (DME, Novolyte Tech.) or diglyme (Sigma Aldrich, 99.5%). The slurry was casted into a Nickel foam disk (outer diameter=12 mm; thickness=1.7 mm) to form a porous carbon air electrode. The Swagelok cell was assembled by stacking a potassium metal foil (Sigma Aldrich, 99.5%), a Whatman glass fiber separator (saturated with an electrolyte (0.5 M KPF₆ dissolved in either DME or diglyme)), and the air electrode. The cell was sealed with an O-ring (Macro Rubber, Viton) except for valves introducing dried oxygen gas at a pressure of 1 atm.

An artificial discharged battery was constructed as described above, except that the electrode was formed using a slurry of carbon powder, PTFE, and KO₂ (Sigma Aldrich) (ratio=1:1:1). All solvents, including diethylene glycol dibutyl ether (butyl diglyme, Sigma Aldrich, >99%) and tetraglyme (Novolyte), were dried over 4 Å molecular sieves. Cell assembly was performed in a glove box filled with high purity Argon.

Electrochemical Tests

Batteries were tested using a Maccor testing station (model 4304), with discharge and charge current density of 0.16 mA/cm² (geometric area) and within a voltage range of between 2.0 V and 3.2 V (vs. K⁺/K). To study the influence of different cations, oxygen reduction reactions were performed in the presence of 0.1 M of different salts, e.g. tetrabutylammonium hexafluorophosphate (TBAPF₆, Sigma Aldrich, electrochemical grade), LiClO₄ (Alfa Aesar, electrochemical grade) and KPF₆. Cyclic voltammetry studies were carried out in a three-electrode system using a Gamry potentiostat, with a glassy carbon working electrode (3 mm diameter), a platinum wire counter electrode, and a Ag⁺/Ag non-aqueous reference electrode (10 mM AgNO₃ in acetonitrile, from CHI Inc.). Acetonitrile was distilled with CaH₂ prior to use.

Characterization

After battery tests, air electrodes were washed with DME to remove residual conducting salt, and then dried under vacuum. The structure of discharge product was characterized by X-ray diffractometer (Bruker D8 Advance, Cu-Kα source, 40 kV, 50 mA) using an air-sensitive sample holder equipped with a moisture barrier film. Raman spectra of the discharged air electrodes were obtained using a microscope Raman spectrometer (inVia, Renishaw) at a 633 nm excitation wavelength (laser power 6 mW) using an air-sensitive sample holder equipped with a ZnSe optical window. Side products in the air electrodes were extracted with D₂O (Sigma Aldrich, 99.9 atom % D) and characterized using ¹H NMR spectroscopy (Bruker, 400 MHz).

Results and Discussion Improved battery designs and chemistries offer the potential to provide batteries that overcome the shortcomings of existing Li—O₂ battery designs. The O₂/O₂⁻ redox couple offers an attractive electrochemical platform for battery development. The O₂/O₂⁻ redox couple is quasi-reversible in aprotic solvents. As suggested by the fact that O₂⁻ has a bond length (1.28-1.33 Å) closer to O₂ (1.21 Å) than to O₂²⁻ (1.49 Å), the energy barrier for the conversion of O₂⁻ to O₂ is lower than the energy barrier for the conversion of O₂²⁻ to O₂. However, a key problem in Li—O₂ batteries is that LiO₂ is unstable due to the high charge density of Li⁺. Based on Hard-Soft Acid-Base (HSAB) theory, O₂⁻ should be increasingly stable with decreasing cation charge density. Potassium ions carry a lower charge density than both lithium and sodium ions. This explains why, in contrast to LiO₂ and NaO₂, KO₂ is commercially available and stable up to its melting point (560° C.).

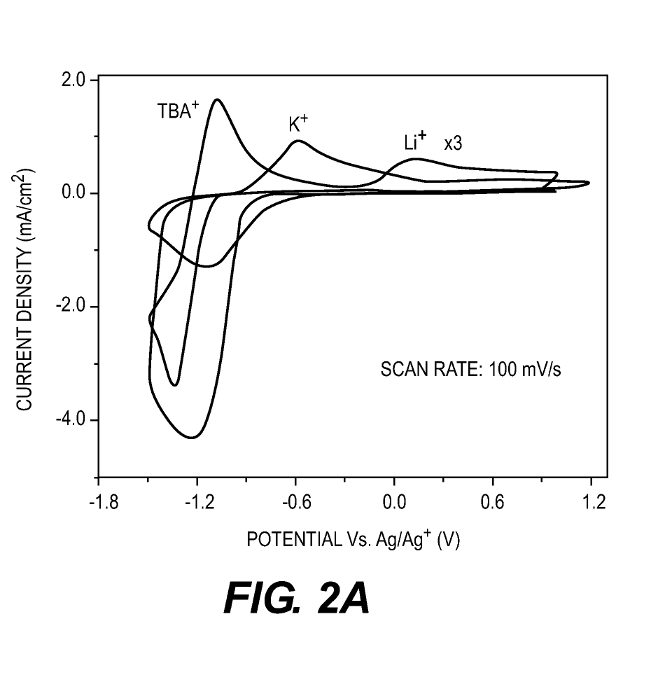

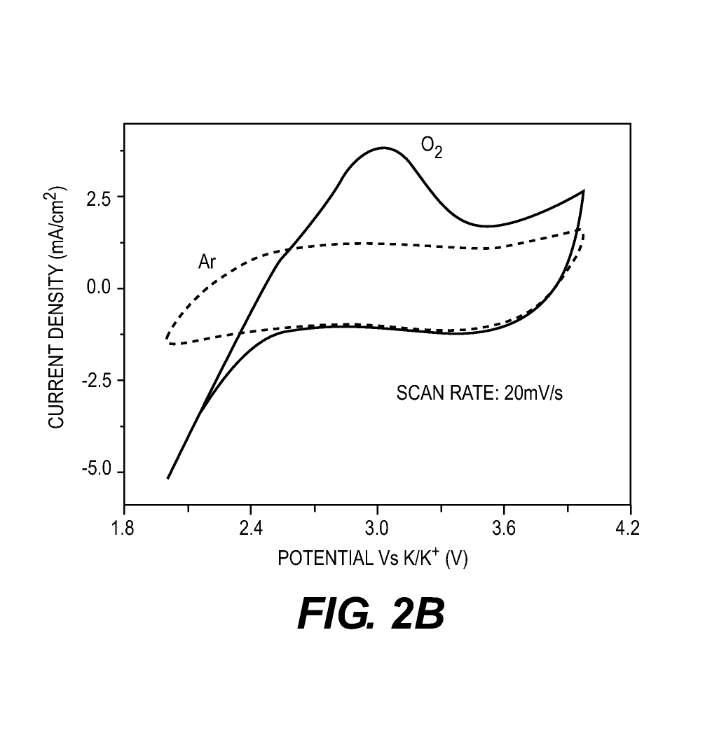

Cyclic voltammograms for oxygen reduction and oxidation on a glassy carbon electrode in the presence of a 0.1 M solution of three different cations (tertbutylammonium cations, 0.1 M TBAPF₆; lithium cations, 0.1 M LiClO₄; and potassium cations, 0.1 M KPF₆) in an aprotic solvent (oxygen-saturated acetonitrile) are shown in FIG. 2A. In the presence of the K⁺ electrolyte, the gap between the oxygen reduction potential and the oxygen oxidation potential is much smaller than the gap between the oxygen reduction potential and the oxygen oxidation potential in the presence of a Li⁺ electrolyte. The higher current density in the presence of the K⁺ electrolyte may be the result of the higher conductivity of KO₂ (˜10 S/cm² at 10° C.). These results suggest that a K—O₂ battery could operate at lower overpotentials (and thus significantly higher round-trip energy efficiency) than a Li—O₂ battery. The reactions expected to occur on the porous carbon electrode during discharging and charging of the battery would be as follows:

Dishcharge: O₂+e⁻+K⁺→KO₂ (1)

Charge: KO₂→O₂+e⁻+K⁺ (2)

The net discharge reaction for the battery would be K+O₂→KO₂ (ΔG⁰=−239.4 kJ/mol, E⁰=2.48 V), corresponding to a theoretical energy density of 935 Wh/kg for the battery (based on the mass of KO₂).

A Swagelok battery was fabricated containing a potassium metal foil, a glassy fiber separator and a porous carbon electrode prepared from a mixture of a SUPER P® carbon powder and a binder in a Ni foam framework. 0.5 M KPF₆ in an ether solvent (1,2-dimethoxyethane (DME) or diglyme) were used as the electrolyte. For purposes of comparison, a Li—O₂ battery was constructed in a similar manner, except that a 1 M solution of LiCF₃SO₃ in tetraglyme was used as the electrolyte.

The electrochemical behavior of the carbon cathode in the K—O₂ battery was investigated by cyclic voltammetry in the two-electrode battery setup (K metal served as the counter and reference electrode). The cyclic voltammograms are shown in FIG. 2B. Before oxygen was purged into the two-electrode battery setup, only the double layer capacitor behavior of carbon was observed. Once oxygen was introduced into the two-electrode battery setup, oxygen reduction and oxidation processes could be clearly seen. The difference between the onset potential for oxygen reduction and the onset potential for oxygen oxidation is relatively small. The oxidation process observed at potentials above 3.5 V is attributed to the decomposition of carbon electrode or electrolyte. This suggests that the oxidation process can be complete within a potential range where the carbon electrode and the electrolyte are relatively stable.

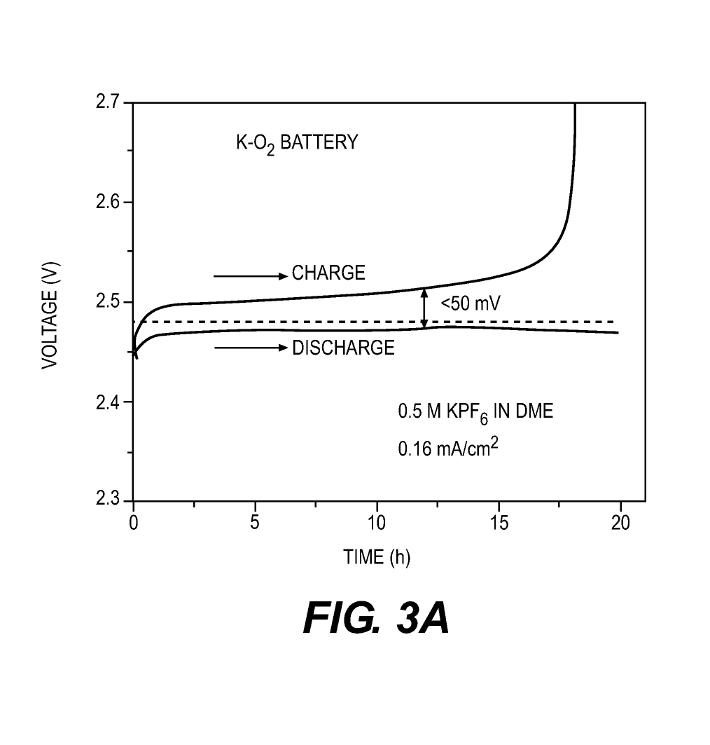

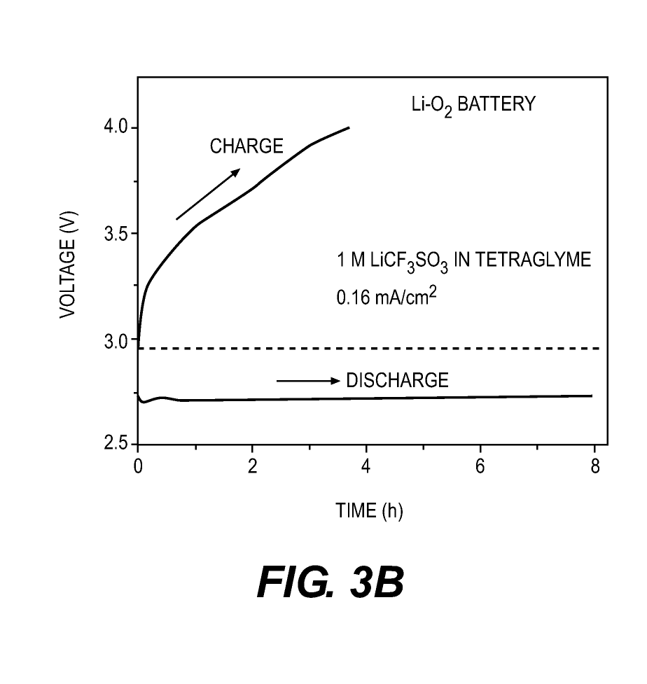

The first discharge and charge voltage profiles of the K—O₂ battery and the Li—O₂ battery are shown in FIGS. 3A and 3B respectively. The stable discharge plateau is at 2.70V (overpotential η_{dischrg}=26 mV) for the Li—O₂ battery and at 2.47V (η_{dischrg}˜10 mV) for the K—O₂ battery. More importantly, in the subsequent charging processes, the voltage is as low as 2.50-2.52 V for the K—O₂ battery. The charge overpotential (η_{chrg}) of ˜20-40 mV observed for the K—O₂ battery is significantly smaller than charge overpotential observed for the Li—O₂ battery. Moreover, within this small charging potential range, almost 90% of the discharged product can be oxidized. In contrast, in the case of the Li—O₂ battery, only half of the discharged product could be removed even when the voltage reaches 4.0V, where the ether electrolyte and the carbon electrode become unstable. The charge/discharge potential gap of about 50 mV observed for the K—O₂ battery is the lowest/discharge potential gap ever reported for a metal-oxygen battery. Compared to the Li—O₂ battery, which has a potential gap of 1V, the K—O₂ battery can provide an exceptional round-trip energy efficiency of >95%.

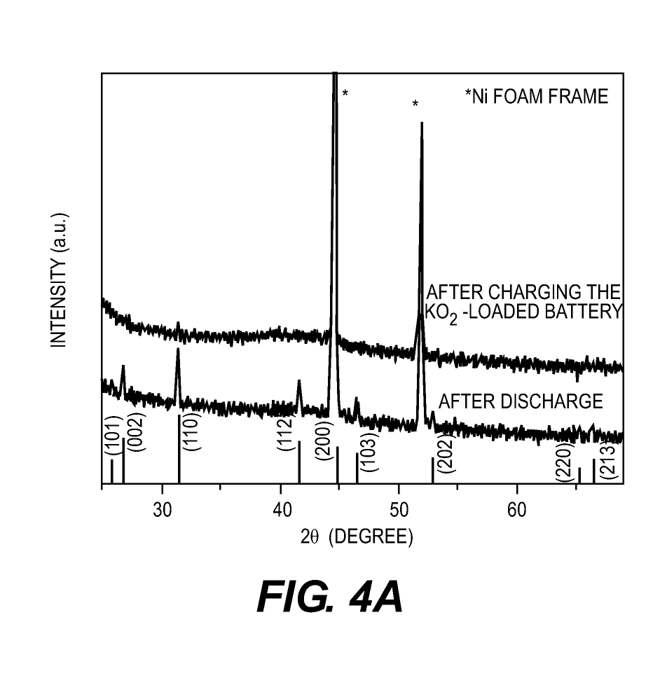

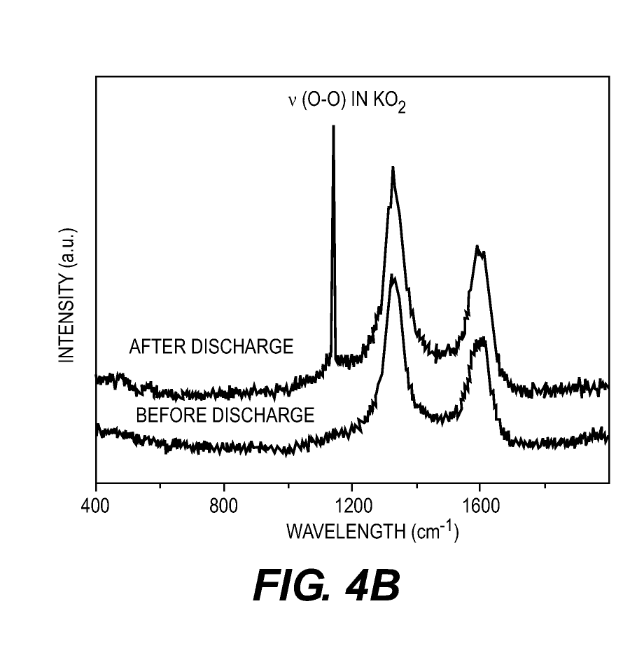

To confirm the formation of KO₂ during discharge, the discharged cathode was characterized by X-ray diffraction and Raman spectroscopy. As shown in FIG. 4A, x-ray diffraction (XRD) analysis confirmed that crystalline KO₂ was the dominant discharge product, as the peaks in the XRD pattern after discharge correspond to peaks in the standard XRD pattern of KO₂. No evidence of other potassium oxides, such as potassium peroxide (K₂O₂) or potassium oxide (K₂O) was seen. Raman spectra of the cathode (see FIG. 4B) also showed the characteristic intense peak of potassium superoxide at 1142 cm⁻¹. The other two broad peaks in the

Raman spectra can be assigned to the G band (1582 cm⁻¹) and D band (1350 cm⁻¹) of the carbon material in the electrode.

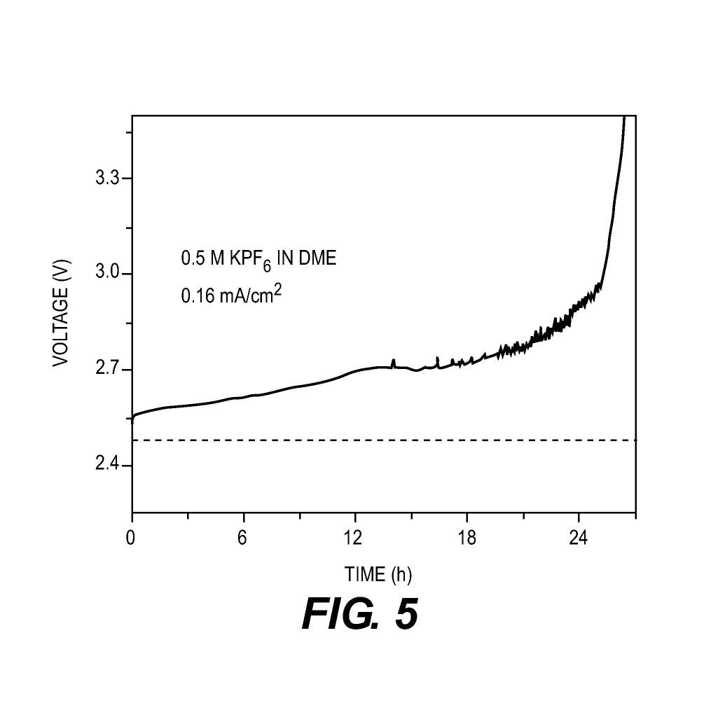

The oxidation of KO₂ at a low overpotential was further confirmed by charging an artificial discharged electrode. The artificial discharged electrode was prepared by loading slurry of hand-milled KO₂, carbon powder, and binder (weight ratio=1:2:1) into a Ni foam. The charge voltage profiles of the K—O₂ battery containing the artificial discharged electrode is shown in FIG. 5. As shown in FIG. 5, the main charge process remains at a low voltage range between 2.55 and 2.90 V. In the absence of KO₂, the voltage goes beyond 4.0 V in less than 10 minutes, suggesting that the reaction observed is the oxidation of KO₂, not the oxidation of the electrolyte. The slight increase in potential relative to the potential shown in FIG. 3A likely results from the fact that electronic contact between this the mechanically mixed KO₂ and carbon in the artificial discharged electrode is not as good as that formed by the electrochemical reaction in the K—O₂ battery. The amount of KO₂ calculated from the total charge flow in the oxidation process was about 6.9 mg, whereas the amount of loaded KO₂ was 8.0 mg. The small difference may be due to some of the initial KO2 particles being loosely bound to the carbon particles. This finding, along with the XRD characterization of the electrode (FIG. 4A) following the charging process that shows only peaks from the substrate Ni foam (with no apparent KO₂ peaks remaining), confirms that the reaction in the charging process is the oxidation of KO₂.

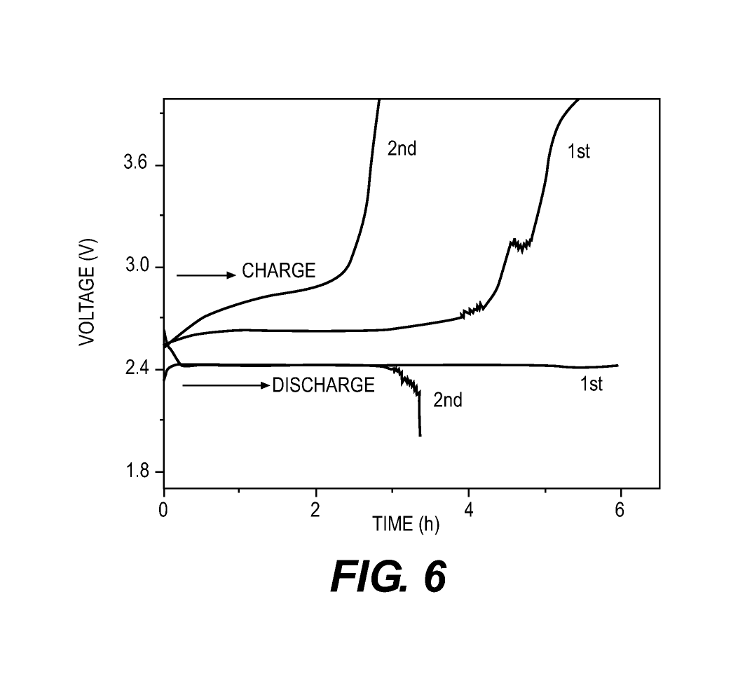

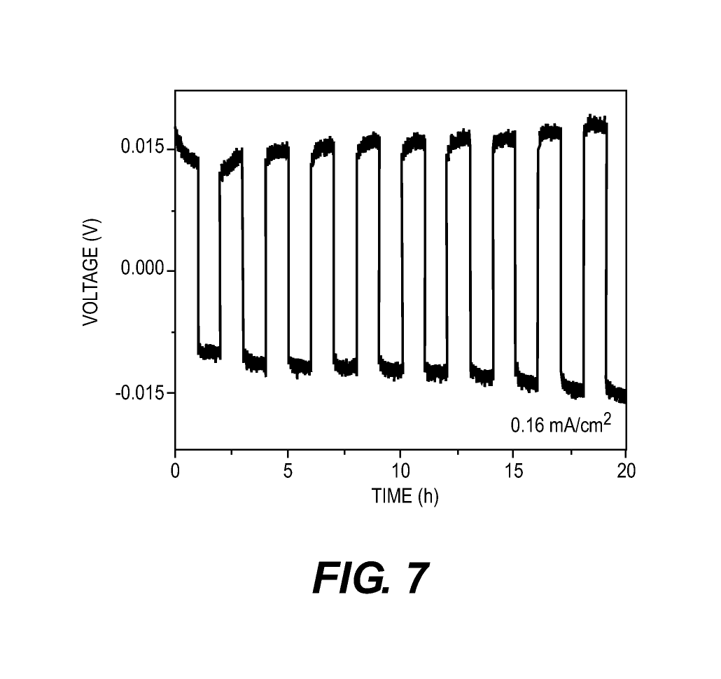

The K—O₂ battery shows several cycles of rechargeability, although the capacity decays with increasing cycle number. As shown in FIG. 6, the charge capacity of the 2nd cycle is only half of the 1st cycle, and the charge voltage is also higher. The recyclability of the K—O₂ battery still suffers due to issues with electrolyte stability. Specifically, reactive superoxide ions react with the ether solvent during battery cycling, forming species such as H₂O, potassium formate (HCOOK) and potassium acetate (CH₃COOK). These species could be identified by ¹H NMR in the electrolyte after battery discharge. The stable voltage profile of potassium electrodeposition and electrodissolution cycles (FIG. 7) suggest that the electrolyte itself is stable when used in conjunction with a potassium metal electrode. However, when side products diffuse to the metal electrode, they can easily react with potassium, forming an insulating layer on the surface of the metal electrode. This phenomenon was visually observed when the K—O₂ batteries were disassembled and inspected after the tests described above. The accumulation of this insulating layer during the course of several cycles of rechargeability likely results in the observed decay in battery capacity.

Conclusions

In conclusion, a major obstacle for developing highly efficient Li—O₂ batteries lies in the large overpotentials of the electrochemical reactions (i.e., the discharge and charge reactions). Described above is a K—O₂ battery that takes advantage of the reversibility of the O₂/O₂⁻ redox couple. The discharge and charge reactions in the K—O₂ battery exhibit significantly lower overpotentials than the discharge and charge reactions in Li—O₂ batteries. The K—O₂ battery exhibits a charge/discharge potential gap smaller than 50 mV at a current density of 0.16 mA/cm². XRD analysis and Raman spectroscopy have confirmed the formation of KO₂ during discharge. Experiments with an artificial discharged battery have confirmed that the reaction in the charging process is the oxidation of KO₂. The discharge product (KO₂) is both kinetically and thermodynamically stable. As a consequence of the stability of the discharge product (KO₂), the K—O₂ batteries can operate under a wider range of temperatures.

The devices of the appended claims are not limited in scope by the specific devices described herein, which are intended as illustrations of a few aspects of the claims. Any devices that are functionally equivalent are intended to fall within the scope of the claims. Various modifications of the devices in addition to those shown and described herein are intended to fall within the scope of the appended claims. Further, while only certain representative devices disclosed herein are specifically described, other combinations of the devices also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A potassium-oxygen battery comprising:
a first electrode comprising potassium;
a second electrode; and
a K⁺ electrolyte solution comprising an ether solvent.

2. The potassium-oxygen battery of claim 1, wherein the first electrode comprises potassium metal.

3. The potassium-oxygen battery of claim 1, wherein the second electrode comprises a porous carbon electrode.

4. The potassium-oxygen battery of claim 1, wherein after discharging the battery, the second electrode comprises potassium superoxide (KO₂).

5. The potassium-oxygen battery of claim 1, wherein the ether solvent comprises a solvent selected from the group consisting of dimethoxyethane, diglyme, tetraglyme, and butyl diglyme.

6. The potassium-oxygen battery of claim 1, wherein the ether solvent comprises a mixture of diglyme and butyl diglyme.

7. The potassium-oxygen battery of claim 1, wherein the K⁺ electrolyte solution comprises KPF₆.

8. The potassium-oxygen battery of claim 1, wherein the potassium-oxygen battery further comprises a separator.

9. The potassium-oxygen battery of claim 8, wherein the separator comprises a glassy fiber separator.

10. The potassium-oxygen battery of claim 1, wherein the potassium-oxygen battery exhibits a discharge/charge potential gap of less than 50 mV at a current density of 0.16 mA/cm².

11. The potassium-oxygen battery of claim 1, wherein the potassium-oxygen battery is rechargeable.

12. A potassium-oxygen battery comprising:
first electrode comprising potassium;
a second electrode; and
an electrolyte;
wherein during discharge of the potassium-oxygen battery, reaction (1) occurs at the second electrode
O₂+e⁻+K⁺→KO₂ (1)
and wherein during charge of the potassium-oxygen battery, reaction (2) occurs at the second electrode
KO₂→O₂+e⁻+K⁺ (2).

13. The potassium-oxygen battery of claim 12, wherein the first electrode comprises potassium metal.

14. The potassium-oxygen battery of claim 12, wherein the second electrode comprises a porous carbon electrode.

15. The potassium-oxygen battery of claim 12, wherein after discharging the battery, the second electrode comprises potassium superoxide (KO₂).

16. The potassium-oxygen battery of claim 12, wherein the electrolyte comprises a K⁺ electrolyte solution comprising an ether solvent.

17. The potassium-oxygen battery of claim 16, wherein the ether solvent comprises a solvent selected from the group consisting of dimethoxyethane, diglyme, tetraglyme, and butyl diglyme.

18. The potassium-oxygen battery of claim 16, wherein the ether solvent comprises a mixture of diglyme and butyl diglyme.

19. The potassium-oxygen battery of claim 16, wherein the K⁺ electrolyte solution comprises KPF₆.

20. The potassium-oxygen battery of claim 16, wherein the potassium-oxygen battery further comprises a separator.

21. The potassium-oxygen battery of claim 20, wherein the separator comprises a glassy fiber separator.

22. The potassium-oxygen battery of claim 16, wherein the potassium-oxygen battery exhibits a discharge/charge potential gap of less than 50 mV at a current density of 0.16 mA/cm².

23-32. (canceled)

33. A potassium-oxygen battery comprising
a first electrode comprising potassium;
a second electrode; and
an electrolyte;
wherein during discharge of the potassium-oxygen battery, a discharge product is formed that is thermodynamically stable and kinetically stable.

34. The potassium-oxygen battery of claim 33, wherein the first electrode comprises potassium metal.

35. The potassium-oxygen battery of claim 33, wherein the second electrode comprises a porous carbon electrode.

36. The potassium-oxygen battery of claim 33, wherein the discharge product comprises potassium superoxide (KO₂), and after discharging the battery, the second electrode comprises potassium superoxide (KO₂).

37. The potassium-oxygen battery of claim 33, wherein the electrolyte comprises a K⁺ electrolyte solution comprising an ether solvent.

38. The potassium-oxygen battery of claim 37, wherein the ether solvent comprises a solvent selected from the group consisting of dimethoxyethane, diglyme, tetraglyme, and butyl diglyme.

39. The potassium-oxygen battery of claim 37 or 38 claim 37, wherein the ether solvent comprises a mixture of diglyme and butyl diglyme.

40. The potassium-oxygen battery of claim 37, wherein the K⁺ electrolyte solution comprises KPF₆.

41. The potassium-oxygen battery of claim 33, wherein the potassium-oxygen battery further comprises a separator.

42. The potassium-oxygen battery of claim 41, wherein the separator comprises a glassy fiber separator.

43. The potassium-oxygen battery of claim 33, wherein the potassium-oxygen battery exhibits a discharge/charge potential gap of less than 50 mV at a current density of 0.16 mA/cm².
